(19) United States
(12) Patent Application Publication
(10) Pub. No.: US 2009/0084101 A1
(43) Pub. Date: Apr. 2, 2009

(54) Apparatuses for Converting Pressure Differences of Gaseous or Liquid Media Into Rotary Motion

(76) Inventor: Christian Erker, Erbendorf (DE)

Correspondence Address: Byrne Poh LLP, 11 Broadway, Ste 865, New York, NY, 10004, US

(21) Appl. No.: 12/238,826

(22) Filed: Sep. 26, 2008

(30) Foreign Application Priority Data
Sep. 27, 2007 (DE) 10 2007 046 115.3

(51) Int. Cl. F01B 17/02; F01B 19/04; F16D 31/02

(52) U.S. Cl. 60/407; 60/412; 60/493

(57) ABSTRACT

Apparatuses for converting pressure differences of gaseous or liquid media into rotary motion are provided. In some embodiments, apparatuses for utilizing the pressure differences of gaseous, vaporous or liquid media by pressure expansion of the media are provided, the apparatuses comprising: a housing having an inner wall with a length; a plurality of hose pieces positioned in the housing on the inner wall with a length corresponding at least to the length of housing wall; inlet valves and outlet valves coupled to the hose pieces that substantially synchronously regulate a sequence of filling and emptying of the hose pieces by the media; a roller that is positioned between the hose pieces, that rotates on an eccentric, and that rotates in connection with the tilling and emptying of the hose pieces; and a shaft coupled to the roller at the eccentric that rotates as the roller rotates.

### CROSS REFERENCE TO RELATED APPLICATION

This application claims the benefit under 35 U.S.C. §119 of German Patent Application 10 2007 046 115.3, filed Sep. 27, 2007, which is hereby incorporated by reference herein in its entirety.

### TECHNICAL FIELD

The disclosed subject matter relates to apparatuses for converting pressure differences of gaseous or liquid media into rotary motion.

### BACKGROUND

Energy, in the form of pressure differences in gaseous and liquid media, is often wasted because it is allowed to escape into the atmosphere. In addition to wasting energy, this introduction of energy stresses the environment.

### SUMMARY

Apparatuses for converting pressure differences of gaseous or liquid media into rotary motion are provided. In some embodiments, apparatuses for utilizing the pressure differences of gaseous, vaporous or liquid media by pressure expansion of the media are provided, the apparatuses comprising: a housing having an inner wall with a length; a plurality of hose pieces positioned in the housing on the inner wall with a length corresponding at least to the length of housing wall; inlet valves and outlet valves coupled to the hose pieces that substantially synchronously regulate a sequence of filling and emptying of the hose pieces by the media; a roller that is positioned between the hose pieces, that rotates on an eccentric, and that rotates in connection with the filling and emptying of the hose pieces; and a shaft coupled to the roller at the eccentric that rotates as the roller rotates.

### BRIEF DESCRIPTION OF THE DRAWINGS

FIG. 1 is a diagram of an apparatus for converting pressure differences into rotary motion in accordance with some embodiments.

FIG. 2 is a cross-sectional diagram of a roller and hoses of the apparatus when the roller is in a first position in accordance with some embodiments.

FIG. 3 is a cross-sectional diagram of a roller and hoses of the apparatus when the roller is in a second position in accordance with some embodiments.

FIG. 4 is a diagram of inlet valves of an apparatus in accordance with some embodiments.

FIG. 5 is a diagram of outlet valves of an apparatus in accordance with some embodiments.

FIG. 6 is a diagram of a bearing of an apparatus in accordance with some embodiments.

FIG. 7 is a diagram of the apparatus with the roller at a different position than in FIG. 1 in accordance with some embodiments.

### DETAILED DESCRIPTION

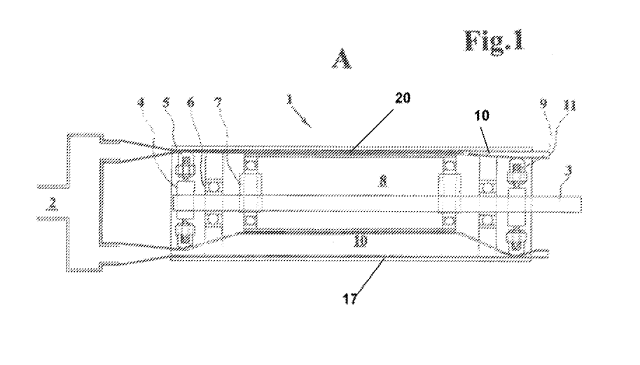

As shown in FIG. 1, the invention relates to an apparatus 1 for utilizing the pressure differences of gaseous, vaporous or liquid media by pressure expansion of the media, that is characterized in that the media to be expanded are suitable for a system of hose pieces 10 positioned on an inner wall of a round housing 17 and with a length corresponding at least to that of housing wall, via inlet valves 5 and outlet valves 9 that synchronously regulate the sequence of the filling and emptying of the hose pieces, in such a manner that the hose pieces are inflated and expanded in series and that a roller 8 rotating on an eccentric is driven by the inflating of the hose pieces, which roller is coupled to a center shaft 3 and causes it to rotate.

The invention addresses the problem of making energy useful that is otherwise not used and frequently escapes into the atmosphere, stressing the environment.

The problem of the invention was solved by an apparatus according to the claims.

The apparatus is described by way of example with the list of reference numerals and the following FIGS. 1 to 7.

The following figures show the apparatus in accordance with the invention and its function.

FIG. 1 shows the apparatus 1 in the exemplary position A with the eccentrically rotating roller 8 in the partial position “medium inlet open”, “medium outlet closed”. FIG. 1 describes the apparatus in detail with the indications of the list of reference numerals. The medium under pressure, e.g., atmospheric air, vapor or water, passes via the medium inlet piece 2, controlled via the inlet valve 5, into the hose pieces 10. The hose pieces inflate and displace eccentrically rotating roller 8 with their active surface and cause it to rotate. As a result, rotational energy is transferred to the rotary shaft 3, the rotor, from the coupled roller 8. The resulting rotational energy is proportional to the medium pressure flowing into hose pieces 10 and to the optimal circumferential hose contact, namely, the active surface of the eccentrically rotating shaft 8. The denser the hose packing in housing 17 and the greater the circumference and the length of the eccentrically rotating shaft 8, the greater the contribution to the output of the apparatus.

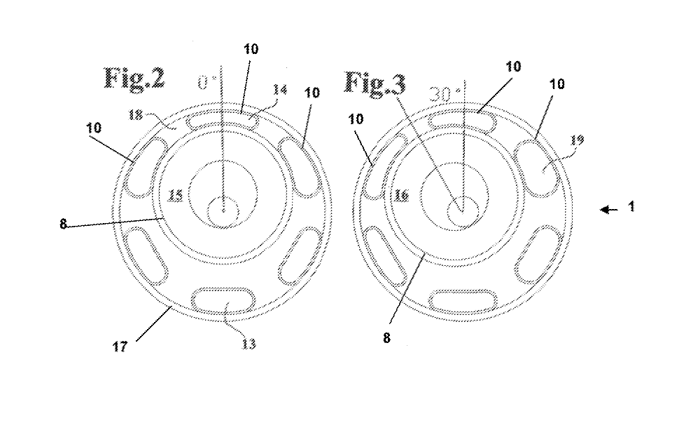

FIG. 2 shows a cross section in the zero position with only partial compression of hose pieces 10. When there is a greater compression by eccentric roller 8, the active displacement surface would be greater.

FIG. 3 shows a cross section of apparatus 1 offset by 30 degrees. The cross-section shows the progressive deformation of hose pieces 10. The counterpressure moves roller 8 in the counterdirection of pressure.

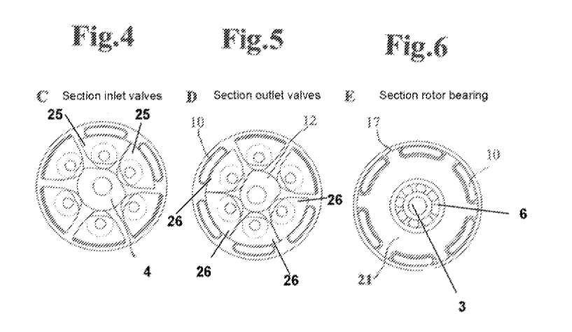

FIGS. 4 and 5 show exemplary cross sections of the valve situations in the positions with open inlet valves 25 as in FIG. 4 and open outlet valves 26 as in FIG. 5. These valves can operate under the control of control disks 4 (FIG. 4) and 12 (FIG. 5), which can be implemented as cams.

FIG. 6 shows a cross section of the bearing of the centered rotary shaft 3 with the bearing 6 and hose pieces 10.

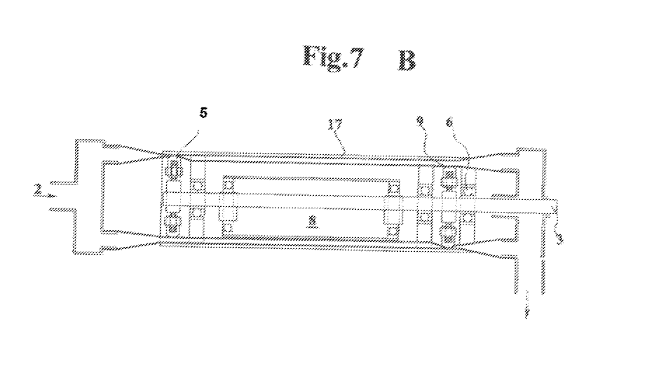

FIG. 7 shows a version of the apparatus with motor function by way of example as in position B. The functioning shown is that for the apparatus in FIG. 1, except that the inlet and outlet pails are changed on account of the directed media currents. It is possible to further use the pressure gradient to atmospheric pressure by configuring multiple apparatuses of FIG. 1 in series.

The figures are shown by way of example and can be expanded.

The output is optimized if housing 17 is provided in such a manner without gaps between the number of hose pieces 10 and if the form of the hose pieces and the form of the eccentrically rotating roller 8 are designed in such a manner that a fluid gap-bridging of gaps 18 can take place, as shown in FIG. 2.

The greater the pressure difference between apparatus inlet 2 and apparatus outlet 11 shown in FIG. 1, the greater the rotary output of rotor 3. No rotary motion takes place if a pressure difference is lacking between the inlet to the apparatus and the outlet of the media from the apparatus. In such an instance, no further blocking valves are necessary.

The utilization of the pressure difference by the apparatus of FIG. 7 also takes place if the pressure difference is not utilized up to atmospheric pressure but rather takes place between different intermediate pressure levels. In such an instance, the apparatus acts like a motor with housing 17 and rotor 3.

Other advantageous functional features of the apparatus are the following:

The valve control takes place by simply clamping off the hoses as is shown with valves 5 and 9 (FIGS. 1 and 7).

At low pressures, the valve control can be implemented with perforated disks.

The direction of rotation can be changed by adjusting the control disks 4 (FIGS. 1 and 4) and 12 (FIG. 5).

The impulsion present as pump function can be converted to pressure fay adjusting control disks 4 (FIGS. 1 and 4) and 12 (FIG. 5).

The apparatus can be used exclusively as a pump by an appropriate controlling of the valves.

The hoses draw in a medium to be pumped on account of their form stability.

In some embodiment, apparatus 1 can be used in a Rankine cycle circuit in the place of a turbine. In the framework of such circuits, the apparatus can be used to produce electrical current by driving an electrical generator, for example, in response to media pressurized by solar heat, geothermal beat, waste heat, etc.

In some embodiments, apparatus 1 can use as its media exhaust gas from an internal combustion engine to provide additional drive energy to a vehicle including the internal combustion engine. In such an arrangement, the apparatus operates as a motor. The apparatus, when operating as a motor, can use media in the temperature spectrum of approximately −1 to +250 degrees Celsius. The apparatus can also be used as a motor to raise the efficiency of refrigerating machines by acting as a throttle for the refrigerating machines, with a refrigerating agent acting as a medium.

An advantage of the present invention resides in the utilization of energies that are otherwise not utilized. The claimed apparatus can be readily produced using generally available raw materials. The energies employed and utilized do not stress the environment since they are usually energies that escape unused. A further advantage is the lubricant-free method of operation of the apparatus as well as the safe handling of combustible media.

A list of reference numerals and indicators, and a corresponding short description for each is shown in the following table:

| Ref No./ | |
|---|---|
| Indicator | Description |
| 1 | Apparatus in accordance with the invention (FIGS. 1 and |
| | 3) |
| 2 | Medium inlet piece (FIGS. 1 and 7) |
| 3 | Centered rotary shaft (rotor) (FIGS. 1, 6, and 7) |
| 4 | Eccentric disk for valve control of the inlet valves |
| | (FIGS. 1 and 4) |
| 5 | Inlet valves (FIGS. 1 and 7) |
| 6 | Rotary shaft bearing (FIGS. 1, 6, and 7) |
| 7 | Eccentric disk for a roller rotating eccentrically on an |
| | eccentric (FIG. 1) |
| 8 | Shaft rotating eccentrically on an eccentric (FIGS. 1, 2, |
| | 3, and 7) |
| 9 | Outlet valves (FIGS. 1 and 7) |
| 10 | Expandable flexible hose pieces (FIGS. 1, 2, 3, and 5) |
| 11 | Medium outlet into the atmosphere (FIG. 1) |
| 12 | Valve control disks (FIG. 5) |
| 13 | Medium-filled hose spaces (FIG. 2) |
| 14 | Hose pieces emptied of medium (FIG. 2) |
| 15 | Eccentrically rotating roller in zero position (FIG. 2) |
| 16 | Eccentrically rotating roller in a rotation offset by 30 |
| | degrees (FIG. 3) |
| 17 | Apparatus housing (FIGS. 1, 2, 6, and 7) |
| 18 | Bridging gap between inflated hose pieces (FIG. 2) |
| 19 | Inflated hose piece (FIG. 3) |
| 20 | Emptied hose pieces (FIG. 1) |
| 21 | Stator as in the motor instance (housing with non-rotating |
| | parts) (FIG. 6) |
| 25 | Inlet valves in open position (FIG. 4) |
| 26 | Outlet valves in open position (FIG. 5) |
| A | Apparatus version with medium pressure gradient to |
| | atmospheric pressure (FIG. 1) |
| B | Apparatus version as motor with partially utilized |
| | pressure gradient (FIG. 7) |
| C | Section inlet valves (FIG. C) |
| D | Section outlet valves (FIG. D) |
| E | Section rotor bearing (FIG. E) |

Although, the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. An apparatus for utilizing the pressure differences of gaseous, vaporous or liquid media by pressure expansion of the media, comprising:
a housing having an inner wall with a length;
a plurality of hose pieces positioned in the housing on the inner wall with a length corresponding at least to the length of housing wall;
inlet valves and outlet valves coupled to the hose pieces that substantially synchronously regulate a sequence of filling and emptying of the hose pieces by the media;
a roller that is positioned between the hose pieces, that rotates on an eccentric, and that rotates in connection with the filling and emptying of the hose pieces; and
a shaft coupled to the roller at the eccentric that rotates as the roller rotates.

2. The apparatus of claim 1, wherein the apparatus is used in a Rankine cycle circuit in the place of a turbine.

3. The apparatus of claim 2, wherein the apparatus is used to drive an electric generator.

4. The apparatus of claim 1, wherein the shaft is the rotor of a motor.

5. The apparatus of claim. 4, wherein the apparatus is used in a Rankine cycle circuit in the place of a turbine.

6. The apparatus of claim 5, wherein the apparatus is used to drive an electric generator.

7. The apparatus of claim 4, wherein the apparatus is used as a pump.

8. The apparatus of claim 1, wherein the inlet valves and outlet valves regulate the sequence by compressing and decompressing the plurality of hose pieces.

9. The apparatus of claim 8, wherein the apparatus is used in a Rankine cycle circuit in the place of a turbine.

10. The apparatus of claim 9, wherein the apparatus is used to drive an electric generator.

11. The apparatus of claim 8, wherein the inlet valves and the outlet valves include perforated disks.

12. The apparatus of claim 11, wherein the apparatus is used in a Rankine cycle circuit in the place of a turbine.

13. The apparatus of claim. 12, wherein the apparatus is used to drive an electric generator.

14. The apparatus of claim 1, wherein the inlet valves and the outlet valves include perforated disks,

15. The apparatus of claim 14, wherein the apparatus is used in a Rankine cycle circuit in the place of a turbine.

16. The apparatus of claim 15, wherein the apparatus is used to drive an electric generator.

17. The apparatus of claim 1, further comprising control disks that control the input valves and output valves, wherein the direction of rotation of the shaft can be changed by adjusting the control disks.

18. The apparatus of claim 17, wherein the apparatus is used in a Rankine cycle circuit in the place of a turbine.

19. The apparatus of claim 18, wherein the apparatus is used to drive an electric generator.

20. The apparatus of claim 1, wherein the apparatus is used as a pump.
